(19) United States
(12) Patent Application Publication
(10) Pub. No.: US 2023/0032571 A1
(43) Pub. Date: Feb. 2, 2023

(54) SYSTEMS AND METHODS FOR AN AGNOSTIC SYSTEM FUNCTIONAL STATUS DETERMINATION AND AUTOMATIC MANAGEMENT OF FAILURES

(71) Applicant: EMBRAER S.A., Sao Jose dos Campos-SP (BR)

(72) Inventor: Felipe Magno da Silva TURETTA, Belo Horizonte - MG. (BR)

(21) Appl. No.: 17/788,242

(22) PCT Filed: Dec. 23, 2019
(86) PCT No.: PCT/IB2019/061307

§ 371 Date: Jun. 22, 2022

(51) Int. Cl. G07C 5/08; B64D 45/00; B64F 5/60

(52) U.S. Cl. CPC G07C 5/0825; B64D 45/00; G07C 5/0808; B64F 5/60; B64D 2045/0085

(57) ABSTRACT

The non-limiting technology described herein is a failure managing framework for complex systems that determines and restores functionality of failing systems and sub-systems using a function-based intervention approach having ontological content such as provided in a System State Graph directed graph. An integration framework allows integration of multiple intervention definition paradigms and selects the best for the current scenario; modifies procedures according to current context by encapsulating operator's tacit knowledge; provides an additional safety net during application of intervention and allows both autonomous operations and assistance to a human operator in the loop.

### CROSS-REFERENCE TO RELATED APPLICATIONS

None.

### STATEMENT REGARDING FEDERALLY SPONSORED RESEARCH OR DEVELOPMENT

None.

### FIELD

The technology herein relates to systems fault determination, and more particularly to automated systems and methods for monitoring the health of a system and automatically detecting and analyzing faults. Still more particularly, the example non-limiting technology relates to automated intervention computing systems and processes based on system intended functions, and to an integration framework for organizing and modifying procedures according to current context, which selects between different intervention definition processes using simulation models as references.

### BACKGROUND & SUMMARY

The Quantas Flight 32 accident as described in https://www.atsb.gov.au/publications/investigation_reports/2010/aair/ao-2010-089.aspx and “In-flight uncontained engine failure Airbus A380-842, VH-OQA” (Australian Government ATSB Transport Safety Report Occurrence Investigation AO-2010-089, 27 Jun. 2013) is an example of what can happen when multiple aircraft systems fail simultaneously. In that accident, which occurred in early November 2010 while climbing through 7,000 ft after departing from Changi Airport, Singapore, the flight crew heard two ‘bangs’. The aircraft had sustained an uncontained engine rotor failure (UERF) of the No. 2 engine due to a fire caused by a crack that had developed in the oil feed pipe, causing the No. 2 engine to catch on fire and begin leaking fuel. Debris from the UERF impacted other parts of the aircraft, resulting in significant structural and systems damage. For example, a turbine disc from the damaged engine rotor detached and punched a huge hole in the wing.

A number of warnings and cautions were displayed on the electronic centralized aircraft monitor (ECAM). The pilot's display indicated twenty-one of the plane's twenty-two major systems were damaged or completely disabled. As the plane's problems cascaded, the step-by-step instructions the ECAS display provided became so overwhelming that no one was certain how to prioritize or where to focus. Because so many systems were damaged, some instructions seemed to contradict other instructions.

Luckily, there happened to be additional crew on the flight deck as part of a check and training exercise, and this additional crew helped in dealing with the failure. Meanwhile, instead of trying to understand the full complexity of the failures, the captain instead began focusing his attention on a simplified mental model of the aircraft. Transcripts of the voice recorder show that the captain said at a certain point: “So forget the pumps, forget the other eight tanks, forget the total fuel quantity gauge. We need to stop focusing on what's wrong, and start paying attention to what's still working.” This was a crucial turning point in the decision-making process. Under the captain's command, the expanded flight crew managed the situation and, after completing the required actions for the multitude of system failures, safely returned to and landed at Changi Airport with no injuries.

Some in the past have tried to address the issue of automatically diagnosing complex failures such as those experienced by Quantas flight 32, but generally speaking, none of them provide a usable automation method to run multiple possibilities in parallel and select the best possibility or possibilities to provide a safety net for non-deterministic processes.

Complex safety critical systems have procedures for operator-intervention in case of failures of specific subsystems or components. Those procedures are usually defined per subsystem or component failure, such as aircraft quick reference handbooks (“QRHs”) that contain procedures such as “Engine Failure”, “Battery 1 Failure” and so on. See FIG. 2 described below. The shortcoming of this approach is that it often assumes only one system has failed. However, in the case of a catastrophic failure of multiple systems such as on Quantas Flight 32, simultaneous failure of multiple systems can render such quick reference handbooks useless.

This is because for a large and/or complex system, in case of complex failures involving multiple subsystems/components or unexpected operation scenarios, it is usually impossible to define procedures for each case due to rapid combinatorial explosion. This makes it difficult for operators to intervene and also makes it difficult to automate the intervention process, even with current artificial intelligence techniques, due to concerns with potential illogical and non-deterministic output(s).

The following shows an example prior art failure response protocol to demonstrate limitations of typical prior art approaches.

Example: Aircraft Environmental Control System

The atmospheric environment outside an aircraft flying at 30,000 feet might be −48 degrees Fahrenheit and only on the order of 4 pounds per square inch. Despite this hostile environment, the aircraft's air handling system components maintain pressurization of about 8 pounds per square inch and 68 degrees Fahrenheit (regulated by the flight crew) with a proper mix of oxygen to other gases including water vapor within the pressurized cabin.

FIG. 1 is a schematic diagram of an aircraft including an environmental control unit 105 for maintaining pressurization, ventilation and thermal load requirements during both ground operations and flight operations. These components maintain proper fresh airflow, pressurization and temperature within the aircraft to support human life and comfort even when the aircraft is flying at high altitudes, low external ambient air pressure and low temperature.

In a typical aircraft, the aircraft fuselage 101 defines a flight deck 103 and cabin zones (106a-106g). The cabin zones 106 are occupied by passengers and flight deck 103 is occupied by crew. The number of occupants typically is a factor used to determine air handling system demand and ventilation requirements.

While the aircraft is flying, the engines 102, 104 provide a convenient source of pressurized hot “bleed” air to maintain cabin temperature and pressure. The normal operation of a gas turbine jet engine 102, 104 produces air that is both compressed (high pressure) and heated (high temperature). A typical gas turbine engine 102, 104 uses an initial stage air compressor to feed the engine with compressed air. Some of this compressed heated air can be “bled” the engine compressor stages and used for cabin pressurization and temperature maintenance without adversely affecting engine operation and efficiency.

During flight operation of the aircraft, bleed air sources include, but are not limited to, left engine(s) 102, right engine(s) 104, and the auxiliary power unit (APU) 116. During ground operation of the aircraft, bleed air sources include, but are not limited to, APU 116 and ground pneumatic sources 118.

Bleed air provided by the APU 116, the left engine(s) 102, and the right engine(s) 104 is supplied via bleed airflow manifold and associated pressure regulators and temperature limiters to the air conditioning units 108 of the aircraft. In this context, the term “air conditioning” is not limited to cooling but refers to preparing air for introduction into the interior of the aircraft fuselage 101. Air conditioning units 108 may also mix recirculated air from the cabin zones 106a-106g and flight deck 103 with bleed air from the previously mentioned sources. An environmental control unit controller 110 controls flow control valve(s) 114 to regulate the amount of bleed air supplied to the air conditioning units 108. Bleed valve(s) 125 are used to select the bleed sources.

Each air conditioning unit 108 typically includes a dual heat exchanger, an air cycle machine (compressor, turbine, and fan), a condenser, a water separator and related control and protective devices. Air is cooled in the primary heat exchanger and passes through the compressor, causing a pressure increase. The cooled air then goes to the secondary heat exchanger where it is cooled again. After leaving the secondary heat exchanger, the high-pressure cooled air passes through a condenser and a water separator for condensed water removal. The main bleed airstream is ducted to the turbine and expanded to provide cold airflow and power for the compressor and cooling fan. The cold airflow is mixed with warm air supplied by the recirculation fan and/or with the hot bypass bleed air immediately upon leaving the turbine.

The environmental control unit controller 110 receives input from the sensors 120 in the cabin zones 106a-106g and the flight deck 103. The pilot or crew also inputs parameters such as number of occupants and desired cabin temperature. Based on these and other parameters, the environmental control unit controller 110 calculates a proper ECS airflow target to control flow control valves 125. The ECU controller 110 provides the air conditioning unit 108 with instructions/commands/control signals 111 to control the flow control valves 125 and other aspects of the system operation. The system typically includes necessary circuitry and additional processing to provide necessary drive signals to the flow control valves 125.

Prior art FIG. 2 is an example of a traditional “component based” procedure, and their parts, for such an environmental control system as shown in FIG. 1. In particular, FIG. 2 shows a typical procedure for the failure of Engine Bleed Air (side 1 or 2) from the aircraft that has been designed with the usual component driven mindset. This procedure has a traditional design, with a linear mindset where blocks of actions are used to troubleshoot the failure mode and once it is identified, another block of actions make a specific treatment for this failure mode. But by taking a deeper look into what each block of action really means we can see their true intent as shown below. Some actions relate to the component itself, loss or degradation of a function, or even propagation to other components. With this meaning or ontology distilled, it is possible to design a better intervention process, that considers the system as integrated, and successfully deal with not only single, but multiple failures.

“Part 1” is directly related to the component—it is ontologically a “Component Reset”, a set of actions with the goal of restoring the state of a particular component or sub-system. When bleed air has failed, the example procedure instructs the flight crew to “push out” the affected bleed button (bleed button 1 or bleed button 2), wait one minute and then push the affected bleed button back in. The goal is to reset the bleed air valve 125 and associated support systems. The flight crew then is instructed to determine whether the “Bleed x Fail” message has been extinguished.

“Part 2” is related to a multiple failure scenario in which both bleeds 1 and 2 are affected. Part 2.1 (and Part 3 below) are ontologically “Components Isolation”, a set of actions with the goal of isolating the component or sub-system after it has been declared inoperative. Part 2.1 instructs the flight crew to push out both bleed button 1 and bleed button 2. Notice that with the component mindset, every separate combination must be analyzed and treated individually, thus making it very difficult to deal with multiple failures in large systems due to combinatorial explosion.

Part 2.2 instructs the flight crew to “exit/avoid” any icing conditions (because the bleed air used to melt ice building up on the wings and fuselage is now presumably inoperative) and hence instructs the flight crew to fly at an altitude of no more than 10,000 feet or the minimum enroute altitude (MEA), whichever is higher, to prevent icing and cabin pressure/temperature control (each of which can depend on bleed air). As is well known, MEA is the altitude for an enroute segment that provides adequate reception of relevant navigation facilities and ATS communications, complies with the airspace structure and provides the required obstacle clearance. Part 2.2 is thus ontologically linked to the Loss of function, and not to the component itself, in this case the loss of the functions “Ice protection”, and “Cabin Pressure/Temperature Control”.

Part 2.3 addresses the possible use of the APU to provide bleed air in lieu of the engines. Part 2.3 states: “If APU is available, maximum altitude for APU in-flight start is 31,000 feet; the flight crew should push the APU on/off button in; and the flight crew should push the APU START button in, thereby activating the auxiliary power unit 116. Part 2.3 is also not related to the bleed subsystem, but to the use of a redundant sub-system that can also provide some function that has been lost, in this case, the APU 116 that can also provide bleed air to pressurize and control temperature in the cabin. Ontologically it is a component activation.

Part 2.4 and part 4 are ontologically “Operational limitations” related to the new configuration of the system (APU 116 providing bleed air for 2.4 and Single Bleed for 4). Part 2.4 defines a maximum operating altitude of 20,000 feet when the APU 116 is being relied on to provide bleed air. There is also a caveat concerning landing configuration when relying on the APU 116 for bleed air.

Part 3 instructs the flight crew to push out certain buttons (i.e., the affected bleed button), and it is also a Component isolation. Part 4 specifies a maximum altitude (e.g., 35,000 feet) and asks the flight crew to determine whether icing conditions are present. If icing conditions are present, Part 4 instructs that an Anti Ice (AI) single bleed procedure is accomplished. Thus part 4 is ontologically a set of operational limitations due to the loss of a function.

The FIG. 2 procedure is tailored specifically to the failure of those particular components (i.e., the engine-supplied Bleed 1 or 2), and considers how this failure will propagate to the system as a whole. If one condition is changed, the procedure might no longer apply (for example if the APU 116 is also not available, or if there is a Bleed 1 from engine 102 and failure of the other engine 104—which means there is no Bleed 2 supply from the failed engine but a failed engine may also cause other complications).

As illustrated in the FIG. 2 example, in the event of a multiple failure or even a single failure in an unexpected operating scenario, operating manuals and procedures generally do not contain guidelines for system intervention, due to difficulties in designing procedures for every conceivable possibility. In those scenarios, it is usually the human operator's responsibility to define the best course of action using her own experience and mental models. Statements like this one can be found on aircraft or other complex safety critical operating manuals. This imposes a burden on the operator, especially if they are inexperienced, or if the situation is too complex to handle. This also makes it impossible to automate those kinds of system interventions, since with this component failure mindset no algorithm can be programmed to deal with tacit knowledge from the operator.

Additionally, prior automated approaches generally do not capture the tacit knowledge of the operator. Rather, prior approaches often have a different focus, address the problem differently or do not have the same coverage (e.g., some address only limited problems such as fire/smoke events). For example:
One prior approach presents a functional display, but it is ontologically different since it has the goal of lowering pilot workload and is focused on normal operations.
Another prior approach provides a method and a display to aid in pilot intervention during failures, but this method is based on system component architecture and not functionally defined features. It also works more like an electronic checklist and provides no way to train an artificial intelligence or automate the intervention process.
A further prior approach provides a way to automate system intervention, but it is focused only on smoke and fire events and also is ontologically different.
A further prior approach provides an example of tacit knowledge capture from an aircraft pilot.
Other prior approaches provide failure management from fields other than aerospace.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The following detailed description of exemplary non-limiting illustrative embodiments is to be read in conjunction with the drawings of which:

FIG. 1 shows an example prior art aircraft system;

FIG. 2 shows a sample of a prior art procedure defined by a component driven mindset;

FIG. 3 shows an example non-limiting embodiment of an Intervention Method Integration framework;

FIGS. 4A-4J are together a flip book animation of a sample System State Graph (SSG) for an aircraft function “Provide Habitable Environment” (to view the animation, display this patent in an electronic reader, size the page so it exactly matches the display screen size, and press “page down” to flip from one image to the next);

FIGS. 5 and 5A show a sample designs of a Functional Display for an Aircraft implementation (Engine 1 Fail Scenario);

FIG. 6A shows an example nuclear system implementation/embodiment;

FIG. 6B shows an example nuclear system; and

FIG. 6C shows an example non-limiting ontological graph for the FIG. 6A system.

### DETAILED DESCRIPTION OF PREFERRED EMBODIMENTS

Example non-limiting embodiments of improved aircraft automated diagnostic and fault detection systems and methods provide the following advantageous features and advantages:
a method for defining an intervention process based on system intended functions rather than based on its components; this improved method is more easily automated due to its nature and can handle multiple failures better than previous methods.
an improved integration framework to organize and modify procedures according to the current context, and select between different intervention definition processes, using simulation models as references; thus allowing the implementation of multiple intervention definition paradigms in parallel and selecting the best one for each specific situation and context, and working as a “safety net” for non-deterministic processes such as artificial intelligence.

Example non-limiting embodiments propose a display or other output that is aimed to help manage abnormal situations and use its structure as a means to allow automated intervention and artificial intelligence training. The kind of tacit knowledge that will be used in specific parts of example methods of embodiments define heuristics. In this case, a “functional based” model may be used by the pilot in order to define the intervention in complex scenarios. Other models are possible such as the architectural model or the energy based model.

This application is technology agnostic and may be applied to any complex system subject to failures that needs intervention in emergency situations. Example non-limiting embodiments are structured in an agnostic manner, and therefore are applicable to any kind of complex system, such as submarines, air carriers, satellites, rockets, etc.

When this specification uses the term “function”, it is referring to a functional capability of a complex system as defined in the systems engineering field of knowledge. Examples of system functions are:
For an aircraft: Providing Thrust, Providing Control In Air, Providing Control on ground, Providing Braking Capability, Providing an Habitable Environment, Providing Navigation Capability, etc.
For a Submarine: Providing Thrust, Providing Control, Providing a Habitable Environment, Providing Navigation Capability, Providing Stealth Capability, etc.
For a Nuclear Plant: Providing power, Providing Reactor Cooling,

Providing Protection from Explosions, Preventing the Release of Radioactive Material, etc.

To better understanding of the non-limiting improved technology, a non-limiting application example in the aeronautical industry (an aircraft) will be described.

Example Integration Framework Overall Description

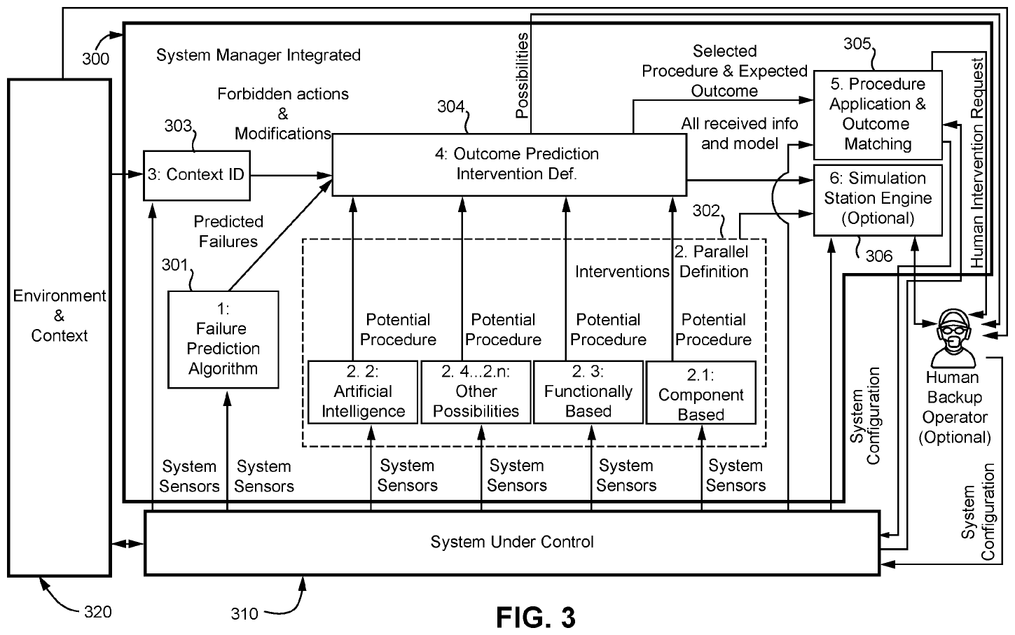

FIG. 3 illustrates an example non-limiting Intervention Methods Integration framework. The proposed framework 300 is shown schematically as a large box on the top of the figure, and the system under control 310 (aircraft, submarine, nuclear power plant, etc.) is shown schematically as a small box on the bottom of the Figure. In this example, the environment and context 320 are acquired by the System Manager Framework 300 through specific sensors (for example, in an aircraft there can be cameras, accelerometers, GPS, Weather information etc.). The System Manager also acquires information from the System Under Control 310 through their sensors.

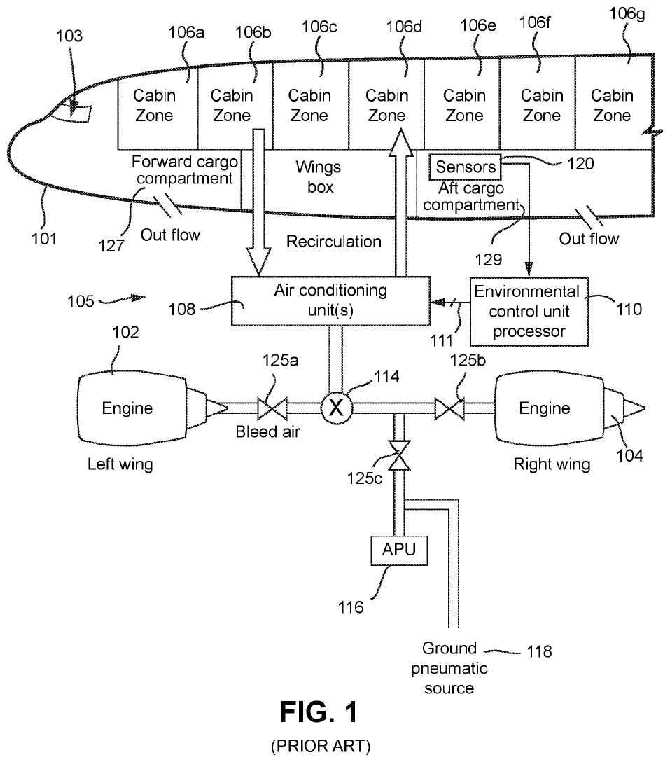

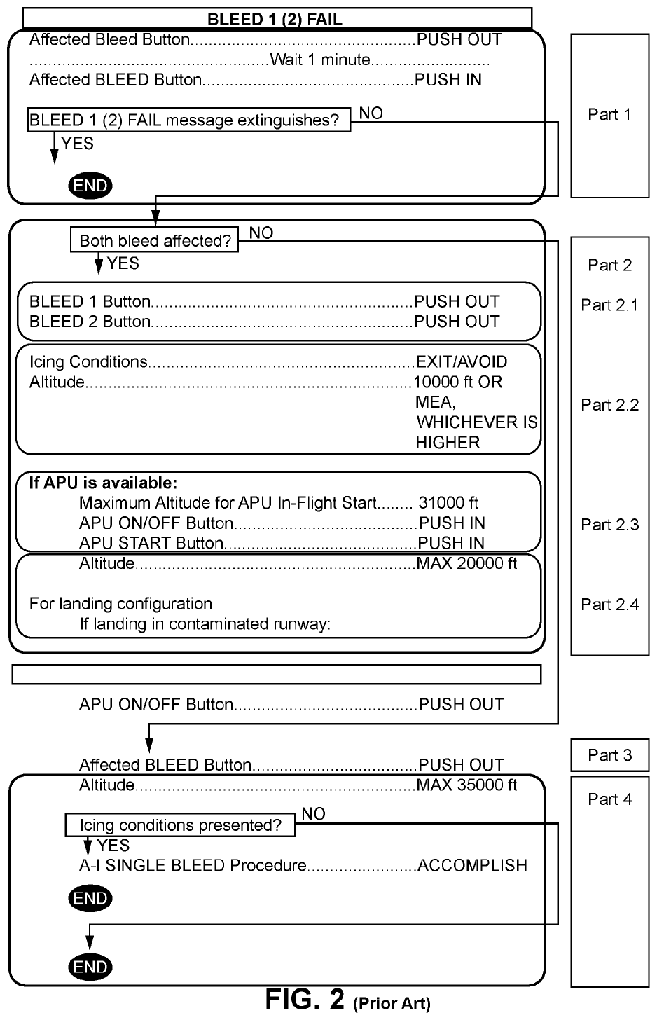

As one specific simplified example, in the case of an aircraft environmental control system of the type shown in FIG. 1, the system under control 310 may comprise the system shown in FIG. 1 (in a typical case, the system under control would comprise many more systems in addition to the FIG. 1 environmental control system such as for example a deicing system, an engine control system, a hydraulic control system to control aircraft control surfaces, a fuel control system, etc.). Sensors 120 on board the aircraft as well as additional sensors not shown in FIG. 1 (e.g., bleed air temperature and pressure sensors at the output of each of valves 125a, 125b, 125c, temperature, pressure and humidity sensors within the air conditioning unit(s) 108, and other sensors) provide sensor inputs from the system under control 310 to system manager 300. In this specific instance, the environment and context block 320 would include additional sensors that monitor external atmospheric pressure, temperature and humidity as well as elevation and other parameters relating to environmental control system operation.

In the example shown, FIG. 3 block 300 may be implemented by one or more computer processors (CPUs and/or GPUs) executing software instructions stored in non-transitory memory; one or more hardware-based processors such as gate arrays, ASICS or the like; or a combination. Block 300 is typically disposed on board an aircraft so its functions can be performed autonomously and automatically without need for externa support, but in some embodiments parts or all of system 300 may be placed in the cloud (such as at one or more ground stations) and accessed via one or more wireless digital communications links and/or networks. For example, high speed satellite communications links can be used to convey data between onboard computers and off-board computers. In such distributed processing systems, onboard computers can provide fallback computation capacity in the event of communications failures.

An example first step in or function of the System Manager Intervention Process is to identify the failure. This is done by the block number (1) in FIG. 3, the failure prediction algorithm block 301. The goal of this block is to identify the specific failures that occurred in the system. Depending on the signals available from the System Under Control 310, it might be a very simple task (if most of the states of the systems are observable, and there are specific monitors for each failure), or a more complex task (if there are more generic monitors to account for several failures or various unobservable signals). This might be implemented by several ways depending on the system, for example a model of the system and its failures that is run with an optimization algorithm to match the inputs and outputs with the real system, by artificial intelligence or other techniques.

The second step is to define the intervention procedure to be applied to the system during a failure event. This is depicted in FIG. 3 by block 2 (“Parallel Interventions Definition” 302). Several different intervention generation algorithms may be executed in parallel. Here, four blocks are shown wherein:
block 2.1 is a traditional database of procedures defined by component failure
block 2.2 is an artificial intelligence algorithm such as a neural network or other machine learning that reads the systems inputs and generates a reconfiguration procedure
block 2.3 is a functionally based System State Graph (SSG) method described below
block 2.4 is a representation to show that the framework can receive other possibilities of procedures interventions.

Block 3 is the Context Identification 303. It reads context information and applies rules extracted from experienced operators to map special situations where some actions on the system are forbidden not only due to the system itself, but also due to the current context. For example, in an aircraft during a left turn, it is not recommended to shut down the left engine, because the momentum from the right engine might be too large to counteract with the rudder only. Thus, during a left engine fire, it is recommended to level the aircraft wings prior to shutting the left engine down. This kind of action (level the wings prior to shutting down the engine) would normally not be on any kind of checklist, because it is situation specific. As another example, assume the action is to descend to 10,000 ft following aircraft depressurization. If the aircraft is currently over the Himalaya mountain range with 29,000 ft ground height, the aircraft should exit this geographical area prior to descending to avoid controlled flight into terrain. This kind of rule is implemented in the Context ID block, which will later modify the procedures proposed by block 2.

Block 4 (“outcome prediction intervention definition” 304) consists of a model of the system and a reward function. The procedures provided by block 2 and modified by block 3 are simulated and the results of the simulation are compared. The best procedure in this specific scenario are chosen though the reward function. Again, the functional ontology may be used to define a suitable reward function, since the goal of the intervention is to maximize system functionality.

It is worth mentioning that when using the functional ontology for training an artificial intelligence, machine learning or a neural network or to define a reward function for selecting the best intervention, it is interesting to use a slightly different (but conceptually equivalent) structure than the one used in the System State Graph (SSG). This is to improve independence of the solutions, since an optimization algorithm will try to maximize the function and may find an illogical solution, so testing and training should have independent metrics. Also, in addition to terms related to the system functionality, other operationally related terms are included in the reward function. Examples of such terms for an aircraft would be for example, fuel consumption, time take to reach the landing site, the relationship between landing distance capability in each configuration versus the runway distances of the potential landing airports, etc. The procedures steps and the expected system behavior after each step will be passed to block 5 for execution. See for example, Krotkiewicz et al, “Conceptual Ontological Object Knowledge Base and Language”, Computer Recognition Systems pp 227-234, Advances in Soft Computingbook series (AINSC, volume 30); Cali et al, New Expressive Languages for Ontological Query Answering, Twenty-Fifth AAAI Conference on Artificial Intelligence (2011); Welty, C. (2003). Ontology Research. AI Magazine, 24(3), 11. https://doi.org/10.1609/aimag.v24i3.1714 (all incorporated herein by reference).

In the example shown, Block 5 (“Procedure Application and Outcome Matching” 305) applies the procedure on the system step by step, and after each step will check if the system behavior is as expected by the simulation. If yes, the execution continues; otherwise, an alert is issued to a human operator (that can be onboard or at a remote location) and the execution is halted, waiting for human action. In some non-limiting embodiments, block 5 serves as a safety net against internal failure in the system manager, since it checks if its own premises and control actions/responses are being satisfied in the real system under control 310. Depending on system design, not all system parameters may need to be checked in this stage, but a select group, or a custom group depending on which kind of action is being taken, may be checked instead. Also, for continuous values (such as temperatures pressures, etc.), acceptable margins of error may be included. Notice that if more than one possible failure was detected in block 1 “Failure identification”, more than one procedure may be passed by the Block 2 “Intervention definition” with more than one possible outcome. Block 5 is responsible for trying the possible procedures, and through outcome matching, define which failure has occurred. This is done by trying first the procedure for the most probable failure (informed by Block 1), and in case the outcomes do not match, revert the actions and try the next one.

Block 6 (“Simulation Station Engine” 306) is an optional part of the framework that is designed in some instances to be used only when the framework is configured to be operated by a human operator, not on autonomous use. Its function is explained in the next section.

Example Use of the Integration Framework for Autonomous Operation or as an Operation Assistant

The Integration framework can be used basically in two ways:
1: As an autonomous agent,
2: As an advisor for human operators

In some applications, it may be best if the non-limiting technology is used as an autonomous agent only after its development is mature and well tested. Minor operator intervention will be requested on the cases where the block 4 “Outcome prediction” does not find any suitable intervention, or if the block 5 “Procedure application and Outcome Matching” finds a mismatch between expected result and actual result.

Still prior to the non-limiting technology maturing or if chosen by designer, the non-limiting technology may be implemented to function as an advisor to the human operator. In this case, the direct link from the system manager to the system under control will be removed, and several displays and functionalities will be provided to serve as the system's Human-Machine-Interface (HMI). The human will have the responsibility of interacting with this HMI, reasoning and then manually interacting with the system under control. Some possible HMI functionalities are described below.

The next section will describe an example non-limiting Integration framework that can be used with one or more defined intervention methods.

Example Intervention Method Integration Framework

In order to implement a solution to manage the operation of a complex system, an integration framework is provided in order to guarantee the correct system function. The FIG. 3 diagram of an example non-limiting improved integration framework thus has the following characteristics:
1. Allows integration of multiple intervention definition paradigms and selects the best for the current scenario.
2. Modifies the procedures according to current context by encapsulating operator's tacit knowledge.
3. Provides an additional safety net during application of the intervention, to guarantee that the real system behavior is as expected.
4. Allows both autonomous operations and assistance to a human operator in the loop that can use the system outputs as action recommendations.

Example Function Based Intervention Method—Ontology

The function-based Intervention method is a system ontology that can be applied to any system to manage failures. Consider that a “System” is a combination of “Sub-Systems” and “Components”, that work together to perform “Functions”. “Sub-Systems” can also be defined as a combination of “lower level subsystems” and “components”. Notice that different abstraction levels can be represented and used when making partitions, and the level(s) used will depend on design characteristics and domain expertise, but more than one division may be applicable to the same system.

In order to implement a Function Based Intervention, it is helpful to divide the system into one suitable abstraction of System, Sub-Systems and Components, and link the behaviors of those parts together with the functions they perform. The system may then be modeled with a data structure (that can be a matrix, a graph or other suitable structure) having “abstract functional” elements such as functions, and also physical concrete elements as the components. The data structure may be stored in non-transitory memory in a conventional form such as nodes as objects and edges as pointers; a matrix containing all edge weights between identified nodes; and a list of edges between identified nodes. The data structure may be manipulated, updated and searched using one or more processors.

After having this or these relationships mapped, suitable interventions may be defined for each element. These interventions are, in example non-limiting embodiments, ontologically linked to their elements and their own states, and do not extrapolate the boundaries of the elements (in some cases the procedures may refer to actions on other components due to system nature but this should be minimized). This ontological link enables the method to work well in different scenarios of multiple failures. In traditional “pure component based” intervention definitions, the procedures contain elements that are related to an own component, to the function they perform, to redundant systems and so on. In this way, the sum of multiple interventions will very easily become useless in a complex multiple failure scenario, since there is too much mixed information in each procedure.

Taking the FIG. 1 process as an example, this is a step by step list that can be grouped in more elementary parts with ontological meaning, as defined by the design of the system and its desired functionality. If those elements can be defined and the relationships mapped (such as which systems perform which function(s), and which is redundant with any other), then a set of more elementary procedures can be written that can be summed in order to define the intervention for a complex set of multiple failures, not only to predefined cases. There are different ways to implement this ontology, and in the next section one of them is proposed.

Example System State Graph Method

This section describes a way of implementing the Function based intervention, herein referred to as System State Graph (abbreviated as “SSG”), since it relies on a representation of the system that is similar to a fault tree, and each node of the graph has a type and current state, that are used to guide the execution of the interventions. The word “System” in SSG has the meaning commonly found on systems theory (Systems Engineering, Bertalanffy such as Bertalanffy, L. von, General System Theory (New York 1969), where a system is considered as an arrangement of components, that perform functions. Only a top-level description is shown here; details are omitted for the sake of readability.

Example SSG Modeling

The first step to implement the SSG method is modeling the system SSG, which in one example non-limiting embodiment is a directed graph wherein the nodes have the following attributes (in addition to a “Name” attribute) as shown in Table I below:

TABLE I

| | States (one state | |
|---|---|---|
| Type | active at a time) | Description |
| Function | (Performing) | Functions that are performed by the |
| | (Lost) | System and supported by one or more |
| | | components/sub-systems. |
| | | If the node directly below the |
| | | function is (Performing), then the |
| | | function is (Performing); otherwise it |
| | | is (Lost). |
| Component | (Fail) | Components or sub-systems that |
| | (Resettable Fail) | perform functions or support other |
| | (Performing) | Components/ sub-systems. |
| | (Avail[able]) | Hereinafter, “component” and “sub- |
| | (Not Avail[able]) | system” are used interchangeably, |
| | | since differences between them are |
| | | related to the level of abstraction |
| | | chosen, not by functionality. |
| | | Non-Critical Failures send the |
| | | component to the (Resettable |
| | | Fail) State. |
| | | Non-Critical Failures followed |
| | | by an unsuccessful |
| | | Component Reset, send the |
| | | component to the (Fail) State. |
| | | Critical Failures send the |
| | | component to the (Fail) State. |
| | | Components with no failures, |
| | | support from their supporting |
| | | systems and turned on, are in |
| | | the (Performing) state. |
| | | Components with no failures, |
| | | support from their supporting |
| | | systems and but not turned on, |
| | | are in the (Avail[able]) state. |
| | | Components with no failures |
| | | but no support from their |
| | | supporting systems are in the |
| | | (Not Avail[able]) state. |
| Degradation | (OK) | Degradations are failures that do not |
| | (Resettable Fail) | render a Component inoperative, but |
| | (Degraded) | cause a degradation/loss in |
| | (Mother Component | performance, and need some |
| | Failed) | treatment. |
| | | If no failure related to the |
| | | degradation occurs, it is in the (OK) |
| | | state. |
| | | Non-Critical Failures send the |
| | | degradation to the (Resettable Fail) |
| | | State. |
| | | Non-Critical Failures followed by an |
| | | unsuccessful Degradation Reset, send |
| | | the degradation to the (Degraded) |
| | | State. |
| | | Critical Failures send the degradation |
| | | to the (Degraded) State. |
| | | If the mother component is in the |
| | | failed state, its related degradations |
| | | are sent to the (Mother Component |
| | | Failed) state. |
| Supports | (Normal Use) | “Supports” maintain a function for a |
| | (Abnormal Use) | limited amount of time, or if a |
| | (Depleted) | specific condition is met. And their |
| | | transitions are different depending on |
| | | their design. |
| | | Example of parts of the system that |
| | | shall be modeled as supports are: |
| | | Fuel (Abnormal use if leaking is |
| | | detected for example) |
| | | Batteries (Abnormal use if abnormal |
| | | discharge is detected for example) |
| Trends | (Present) | Trends are Boolean variables that |
| | (Not Present) | represent external monitors to the |
| | | system, that are capable of rendering |
| | | a Function or component Failed or |
| | | Lost in different conditions. |
| Functional | | Functional Thresholds have only one |
| Thresholds | | state, as they serve only to mark in |
| | | the SSG, the point where the |
| | | functional domain (abstract) is |
| | | separated from the architectural |
| | | (physical) domain. It is used in the |
| | | search algorithms. |
| Logics | (Active) | Logics only represent the |
| | (Inactive) | relationships between the other types |
| | | of nodes, they can be (AND) or (OR) |
| | | gates, and are (Active) if their |
| | | condition is met, otherwise they are |
| | | (Inactive) |

As is well known, a directed graph is a graph that is made up of a set of vertices or nodes connected by edges, where the edges have a direction associated with them.

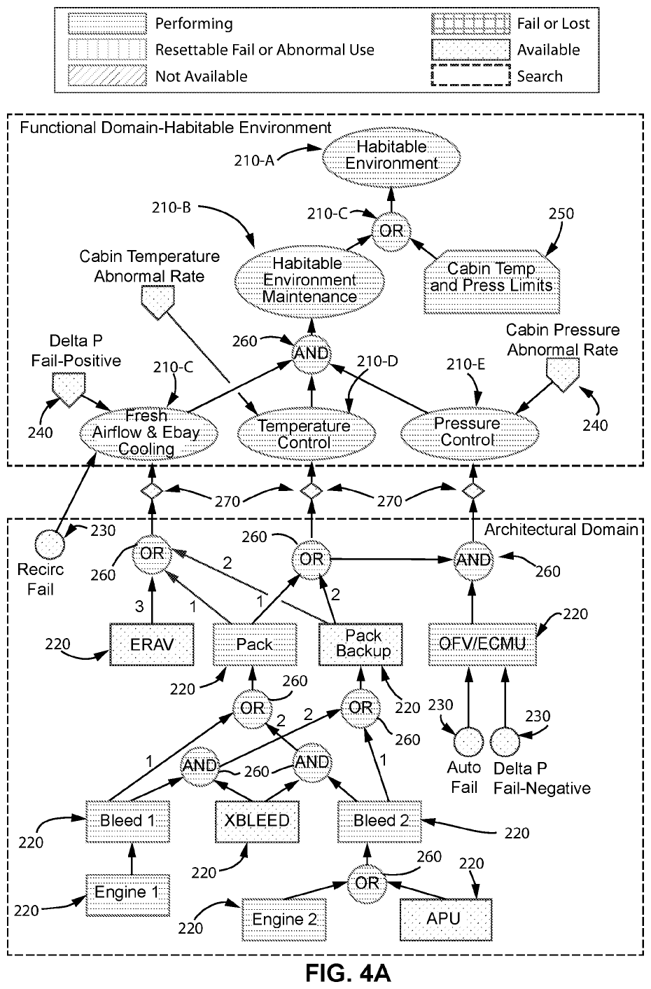

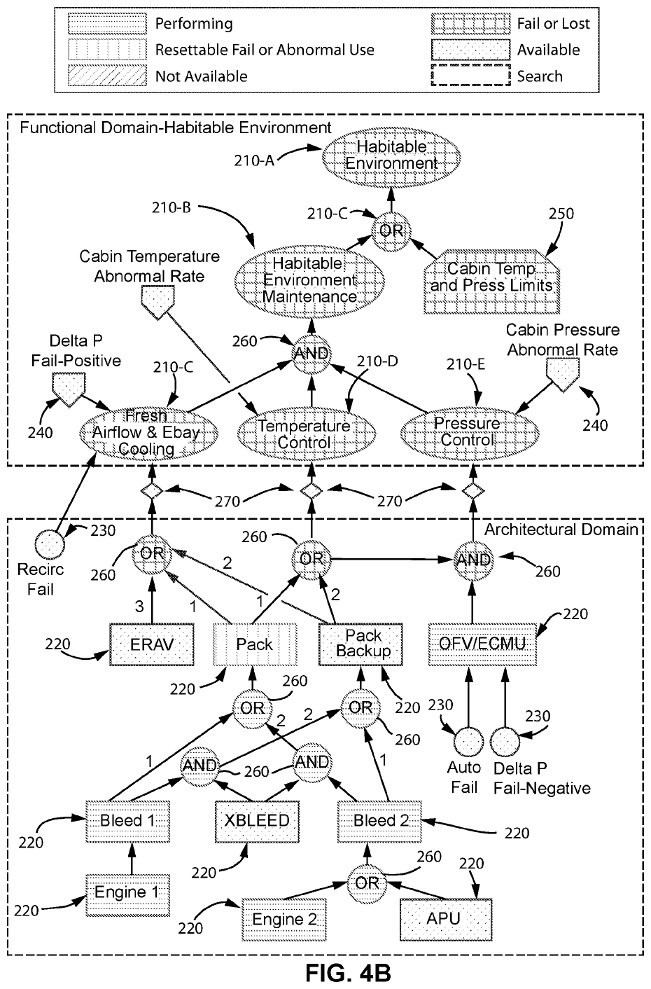

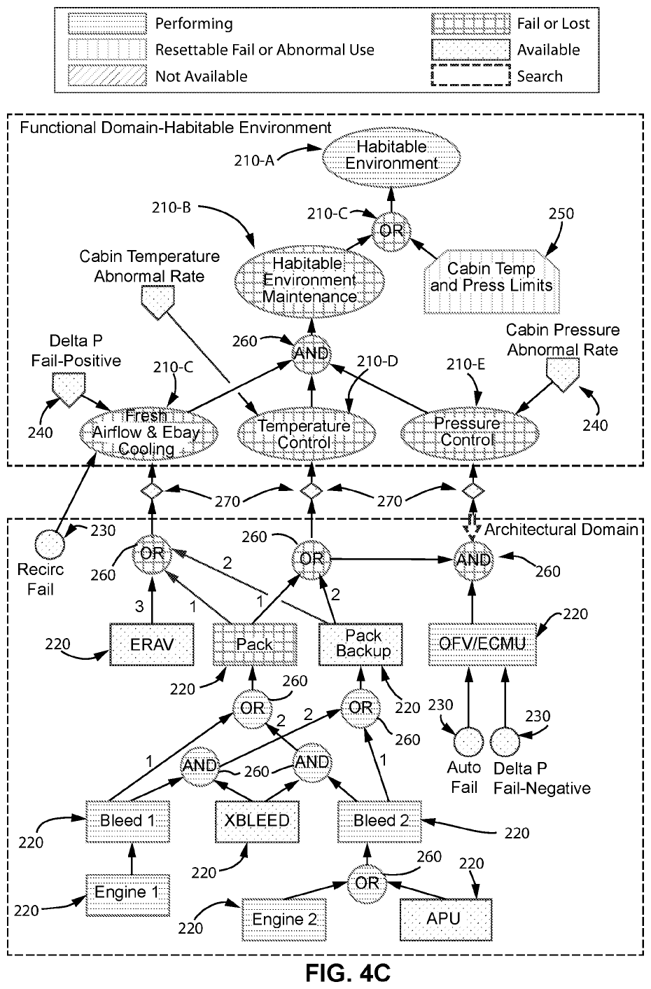

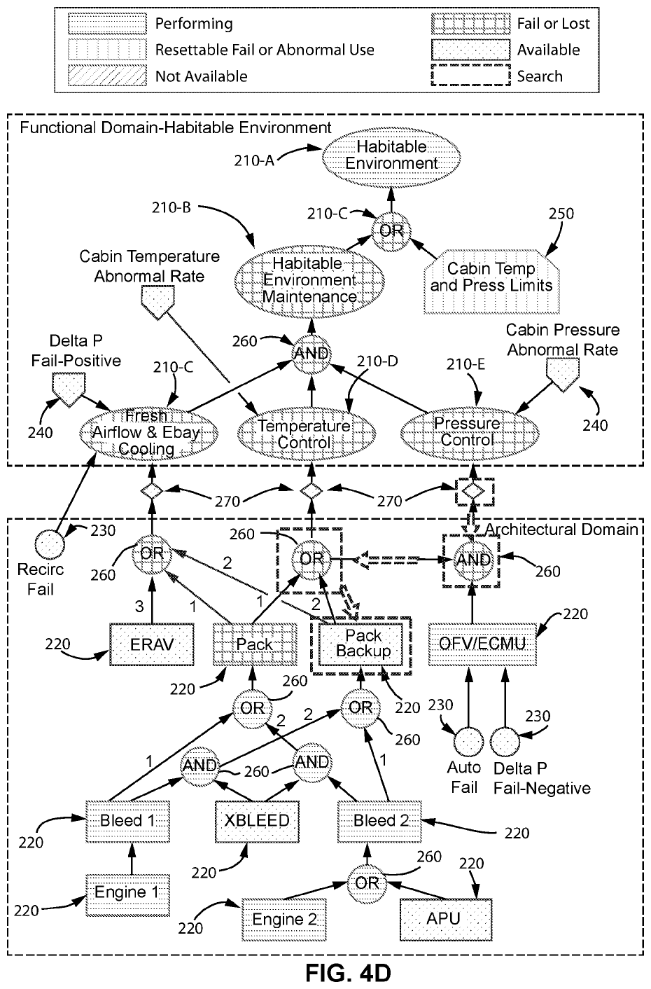

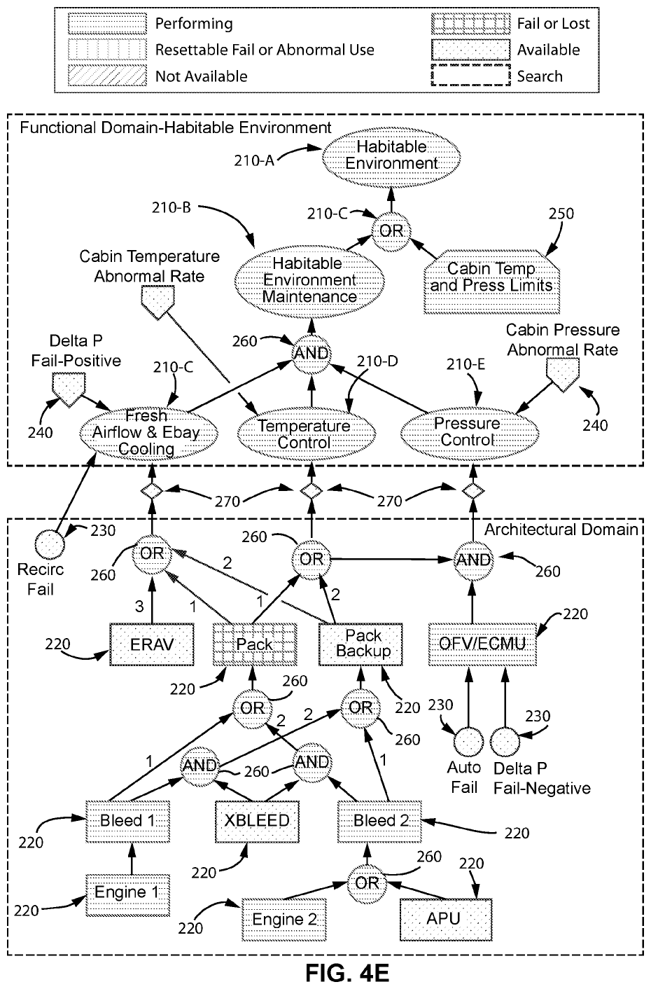

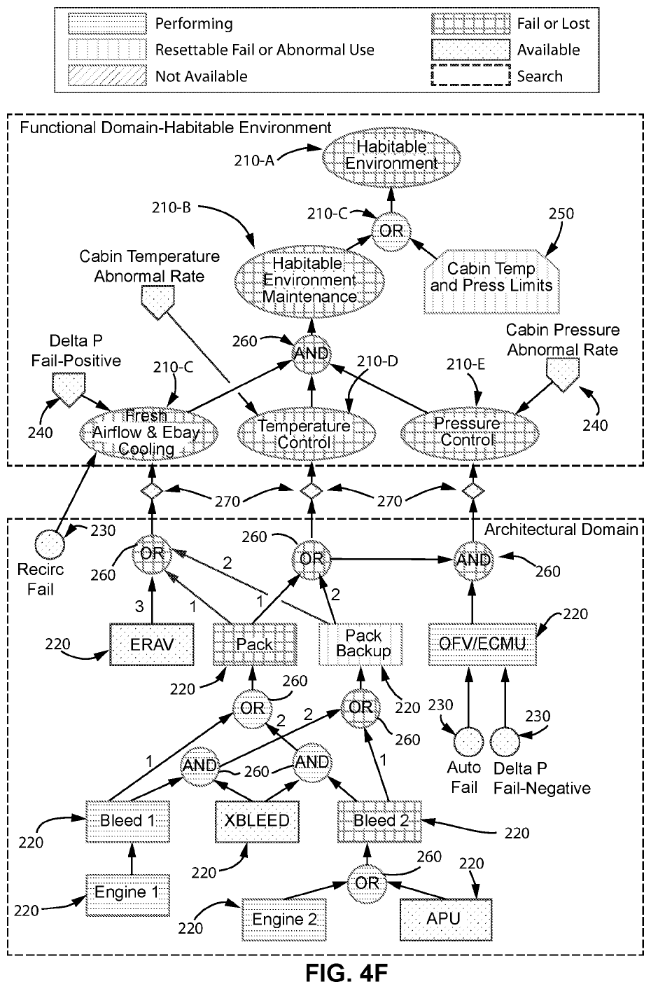

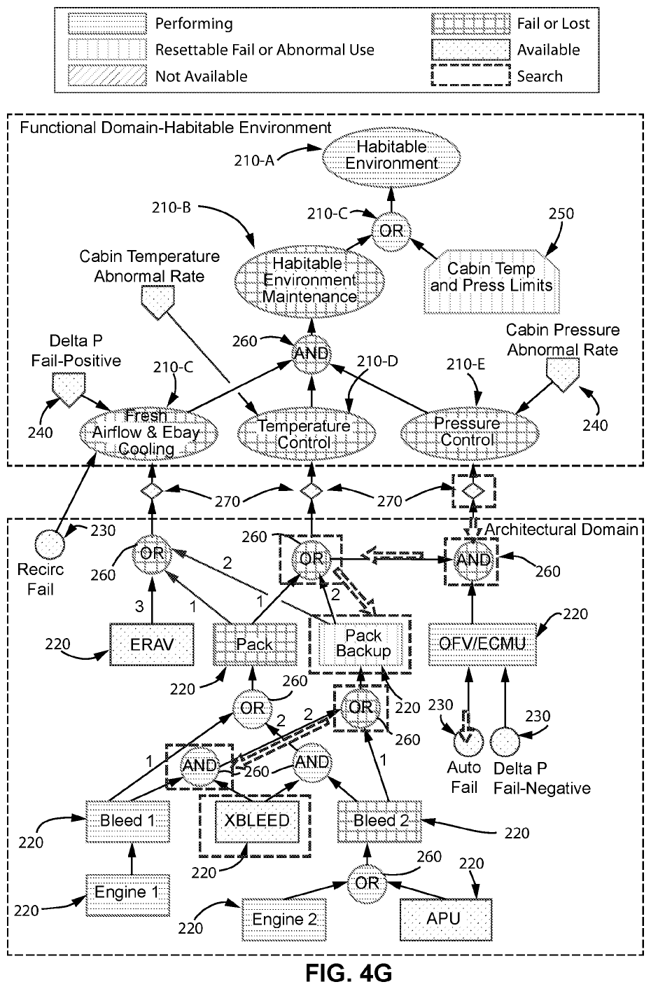

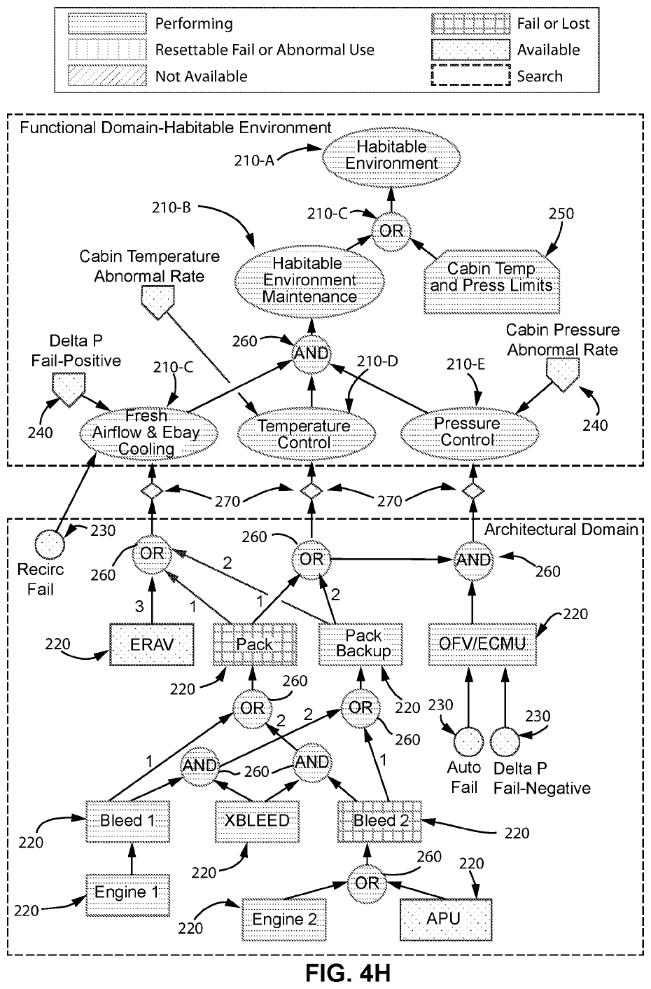

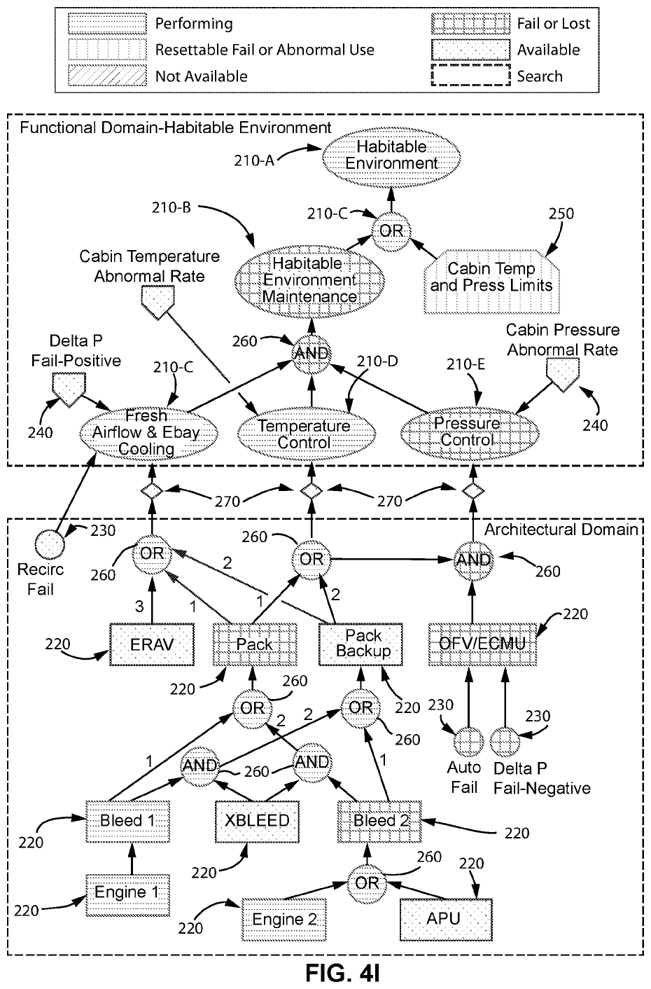

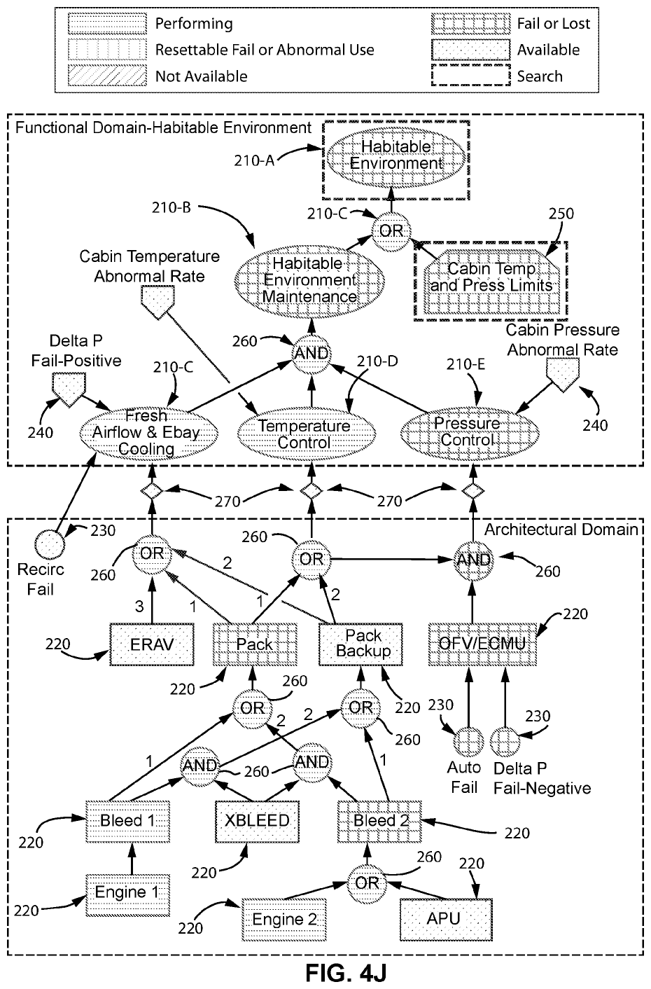

In example non-limiting embodiments, the system is classified into the elementary parts and their relationships mapped in a directed graph. FIG. 4A shows a sample SSG directed graph for “provide habitable environment” where:
Functions are represented by ellipses (plural of ellipse, namely oval shapes) (210-A, 210-B, 210-C, 210-D, 210-E),
components are represented by rectangles 220,
Degradations are represented by circles 230,
Trends are represented by downward arrows 240,
Supports are represented by a rectangle with beveled top edges 250,
Logics 260 are represented by text, and
Functional Thresholds are represented by diamonds 270.

Note how the diamonds divide the functional (upper) and architectural (lower) domains.

The upper functional domain of the graph comprises function nodes, and the lower architectural domain of the graph comprises component nodes. Thus, in the lower “architectural” domain shown in FIG. 4A, Engine 1, Engine 2, Bleed 1, Bleed 2, Out Flow Valve (OFV) and Pack primary components are represented respectively by rectangles 220. Backup components such as APU Bleed, XBLEED, Emergency Ram-Air Valve (ERAV) and Pack Backup are represented by additional dotted rectangles 220. Degradations such as “Auto Fail”, “”Delta P' fail” and “Recirc Fail” are represented by dotted circles 230 with no words in them. Logic operations (which provide combinatorial logic) are represented by solid circles 260 containing words such as Boolean logic statements, e.g., AND and OR.

In the functional domain of FIG. 4A, the function nodes “Habitable Environment”, “Habitable Environment Maintenance”, “Cabin Temperature and Pressure Limits”, “Pressure Control”, “Fresh Airflow” and “Temperature Control” are represented by respective ellipses (two or more ellipse shapes) 210, and “Cabin Pressure Abnormal Rate” and “Cabin Temperature Abnormal Rate” are represented by downward arrows.

As noted above, the diamonds 270 between the architectural domain and the functional domain represent functional thresholds. Note further that the functional domain (top of figure) is abstracted from the architectural domain (bottom of figure) so that the functional domain is not specific to or dependent on any particular components the architectural domain describes, but instead depends in this case on logic outputs and one degradation input the architectural domain outputs. In some embodiments, the functional domain is independent of the particular aircraft or other platform, and different specific architectural domains can be used depending on different aircraft configurations (e.g., twin engine, four engine, etc.)

Example Types of Procedures

After modeling the SSG, the procedures for each node state are defined. Those procedures are executed at nodes transitions or when requested by a monitoring algorithm. Those procedures are ontologically different from the ones defined with an architectural mindset, as explained previously. Examples of such procedures are shown in Table II below:

TABLE II

| | | Performed when*: (procedure might |
|---|---|---|
| | | also be requested by the SSG search |
| Node Type | Procedures types | algorithm directly) |
| Function | Loss Of Function - | Immediately when function is lost |
| | Expeditious | |
| | Loss Of Function | After function is lost, and the SSG |
| | | search algorithm has finished the |
| | | recovery search and was |
| | | unsuccessful. |
| Component | Component Reset | When component Transitions to |
| | | (Resettable Fail) |
| | Component | Immediately when component |
| | Isolation | transitions to Fail. |
| | Component | When requested by the SSG search |
| | Activation | Algorithm. |
| Degradation | Degradation Reset | When Degradation Transitions to |
| | | (Resettable Fail) |
| | Degradation | When Degradation Transitions to |
| | Mitigation | (Degraded) |
| Supports | Support Abnormal | When Supports Transitions to |
| | Use | (Abnormal Use) |
| | Support Depleted | When Supports Transitions to |
| | | (Depleted) |
| Trends | not applicable | not applicable (used by the SSG |
| | | search algorithm) |
| Functional | not applicable | not applicable (used by the SSG |
| Thresholds | | search algorithm) |
| Logics | not applicable | not applicable (used by the SSG |
| | | search algorithm) |

Example Non-Limiting SSG Search Algorithm

In example embodiments, the SSG search algorithm is a monitoring routine that monitors the SSG states, and calls the procedures when applicable. With a simple solution, it is able to search through the SSG and reconfigure the system according to different situations. It monitors all states at a (polling or other reporting) frequency defined depending on system dynamics and do the following:

Execute any (Loss Of Function—Expeditious)
Execute any (Component Isolation)
Clear any variable from a restored function compared to the previous cycle
Execute Component Reset on any component on the (Resettable Fail State)
Execute Top-Down Functional Search as described below
Execute (Loss of functions)

SSG Top-Down Functional Search Description

In one example embodiment, a search is initiated at every functional threshold, and goes down the SSG to try to recover a lost or degraded function.

In example embodiments, the search has the following simplified routine:
1. Go down the SSG one node:
   a. If it is a Component—Try to recover it through reset or activation or continuing the down search as applicable (depending on the state). If it is failed, Exit Search.
   b. If it is an AND Gate, go down (traverse the Logics) and try to recover all the nodes supporting it, one at a time. If one component Fails, Exit Search (As all of the supports are required to activate an AND gate).
   c. If it is an OR Gate, go down (traverse the Logics) and try to recover the nodes supporting it, one at a time, following the priority defined in the directed graph edges. If one of the nodes becomes (Performing), Exit Search (As only one support is required to activate an OR gate).

Notice that both the top-down search is recursive, and in case it finds (not available) components, it will go down the graph and continue to try to restore the state of the nodes above by following the same rules.

Notice also that this is only one possible search algorithm. Many others may be developed over the same structure. One possible solution is to have the search being started from the failed component and try to restore the system from bottom-up. In other embodiments, a mixed approach may be applied. In addition, the example non-limiting embodiments are not limited to AND and OR Boolean logic, but can use any type of combinatorial logic such as NAND, NOR, and multiple-input logic functions.

Example SSG Method Sample Execution

This section presents a sample of the method execution to illustrate how it works, on the graph of FIG. 4A.

In the FIG. 4A diagram, the key at the top left shows different indicators indicative of states indicated by different kinds of line graphics. A solid thick line (green color or associated crosshatch pattern) indicates “performing.” A solid thin line (red color or associated crosshatch pattern) indicates “Fail or Lost.” A double thin line (yellow color or associated crosshatch pattern) indicates “resettable fail or abnormal use”. A thick broken line means “search.” A thin broken line (blue or associated crosshatch pattern) means “available”. A broken line comprising alternating dots and dashes (orange or associated crosshatch pattern) means “Not Available.”

The following example SSG traversal and analysis is explained in conjunction with a flipbook animation of FIGS. 4A-4J.

Example Pack Failure
1. FIG. 4A shows the System Operating Normally.
2. FIG. 4B shows the Pack suffering a non-critical failure. Most functions are lost and Cabin Temperature/Pressure Support is dropping abnormally due to lack of inflow. Habitable Environment Maintenance, Pressure Control, Fresh Airflow and Temperature Control are all lost, and Cabin Temperature and Pressure limits are in the state of Resettable Fail or Abnormal Use. The state of “Pack” is also Resettable Fail or Abnormal Use.
3. SSG Search first cycle initiates:
4. Procedure (Loss of “Habitable Environment Maintenance”—Expeditious actions) are performed (Initiate descent to 10,000 ft, in order to protect the passengers and crew). The other 3 functions do not have Expeditious actions.
5. Procedure (Pack Reset) is performed. In this example, the Procedure is unsuccessful and the “Pack” Transitions to (FAIL) (see FIG. 4C).
6. The search then tries to determine why the “Pressure Control” is lost (see FIG. 4D). A top down search initiates from the sub function with the greatest priority (Pressure Control). Note that an “AND” gate is part of the logic supporting “Pressure Control”. The AND gate means that the associated function will fail if either (or both) of two (or more) supporting functions fail. The search therefore traverses down the graph and finds this AND Gate. From the AND Gate, the search further traverses down and determines that “OFV” is Performing. Since the problem is not OFV, it must be in the other AND gate input. The search therefore traverses to the second node which in this case is an OR gate that ORs two inputs:, Pack and Pack Backup.
7. Since it is an OR gate and Pack Is failed, the search descends to Pack Backup. It then calls for the (Pack Backup—Activation) Procedure. See FIG. 4D circle in the “Pack Backup” block.
8. Pack Backup Transitions to (Performing). System Is restored. See FIG. 4E.
9. In the next cycle, the variable that limits the system imposed by the Procedure (Loss of “Habitable Environment Maintenance”—Expeditious actions) is removed and the aircraft can return to the operating ceiling.

Example Non-Limiting Pack Failure with Subsequent Bleed 2 Failure
1. Assume the system is operating in the configuration of FIG. 4E with the “Pack” indicating Failed but all other functions still operating normally.
2. Then assume that Bleed 2 Suffers a Leakage (critical failure), thus transitions directly to (FAIL). Pack Backup loses the support it had from Bleed 2 and becomes (Not Avail). Now “Habitable Environment Maintenance”, “Pressure Control”, “Fresh Airflow” and “Temperature Control” functions show Fail, the Cabin Temperature and Pressure Limits are Resettable Fail or Abnormal Use, the “Pack” continues to show fail, “Bleed 2” shows Fail, and “Pack Backup” shows “Not Available.” See FIG. 4F.
3. SSG Search first cycle initiates:
10. Procedure (Loss of “Habitable Environment Maintenance”—Expeditious actions) are performed (Initiate descend to 10,000 ft). The other 3 functions do not have Expeditious actions.
4. Procedure (Bleed 2 Isolation) is performed. Bleed is isolated successfully
5. Top down search (see FIG. 4G) initiates from the sub function with the greatest priority (Pressure Control), it traverses down the graph and finds an AND Gate and traverses further downward to determine that OFV is Performing. The search then traverses to the second node which is an OR gate. Since it is an OR gate and Pack Is failed, it descends to Pack Backup. (This is the same as the previous example)
6. Since Pack Backup is now (Not Avail), the search descends the graph to try to recover Pack Backup and finds an OR gate. Since the first priority (Bleed 2) is failed, the search goes to the second priority and finds an AND gate. See FIG. 4G.
7. The search finds the Bleed 1 already Performing; thus, it calls the procedure for XBLEED Activation.
8. The XBLEED Activates Successfully and the system is restored. See FIG. 4H.
9. In the next cycle, the variable that limits the system imposed by the Procedure (Loss of “Habitable Environment Maintenance”—Expeditious actions) are removed and the aircraft can return to the operating ceiling.

Example Pack Failure with subsequent Bleed 2 Failure and Subsequent OFV failure
1. For this example, assume the system was operating in the configuration shown in FIG. 4H with the Pack component indicating FAIL and the Bleed 2 also indicating FAIL.
2. Assume that the OFV then suffers a critical failure as shown in FIG. 4I. The Pressure Control and Habitable Environment Maintenance functions each indicate “FAIL”, the Cabin Temperature and Pressure Limits indicate Resettable Fail or Abnormal Use, and the OFV and its inputs both indicate FAIL.
3. SSG Search first cycle initiates:
4. Procedure (Loss of “Habitable Environment Maintenance”—Expeditious actions) are performed (Initiate descend to 10,000 ft). The Pressure Control function do not have Expeditious actions.
5. Procedure (OFV 2 Isolation) is performed. OFV is isolated successfully (see FIG. 4I).
6. A top down search initiates from Pressure Control. It traverses down and finds an AND Gate and traverses further down to determine that OFV is Failed. The system thus exits the search (the function is lost).
7. The Loss of Pressure Control Function is performed, and in addition to descending to 10,000 ft, a diversion to the nearest airport is recommended. Upon arriving at 10,000 feet, a pressurization dump is performed by e.g., opening a dump valve and dumping cabin pressure to the outside atmosphere. The cabin pressure is thus harmonized with external pressure and the support is depleted. See FIG. 4J, which shows the “Cabin Temp and Press Limits” changing from yellow to red.
8. The Loss of Habitable Environment procedure is performed. An emergency descent to 10,000 ft is required, but the aircraft is already at 10,000 ft. Notice how the sub-functions below and the Cabin Temp and Pressure Limits support are used to avoid an unnecessary Emergency Descend (only a normal descend). Should the pressure have dropped substantially, the support would be depleted earlier, and the emergency descend would have been performed.

With the above three examples, it becomes easy to see to power of the example non-limiting method and system, and how example embodiments would adapt in different situations. If for example in the second example instead of the Bleed 2 Failure, the Engine 2 had failed, the algorithm would activate the APU to provide Bleed air.

Notice also that in this example the SSG was modeled to a certain point (finishing on the engines and APU). When the system gets bigger, the method may be applied with different graphs for different major functions, or with only one single integrated graph connecting all the systems and subsystems.

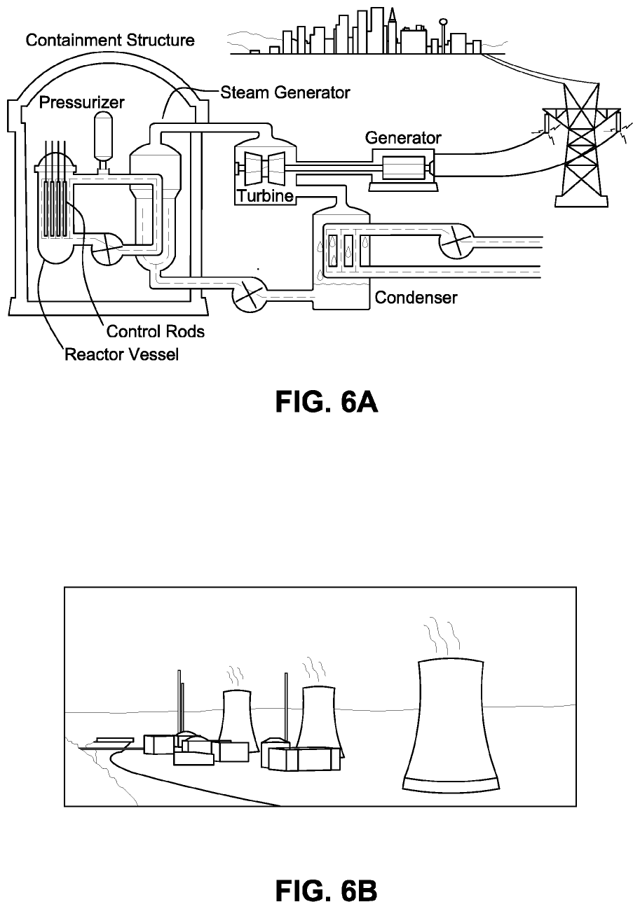

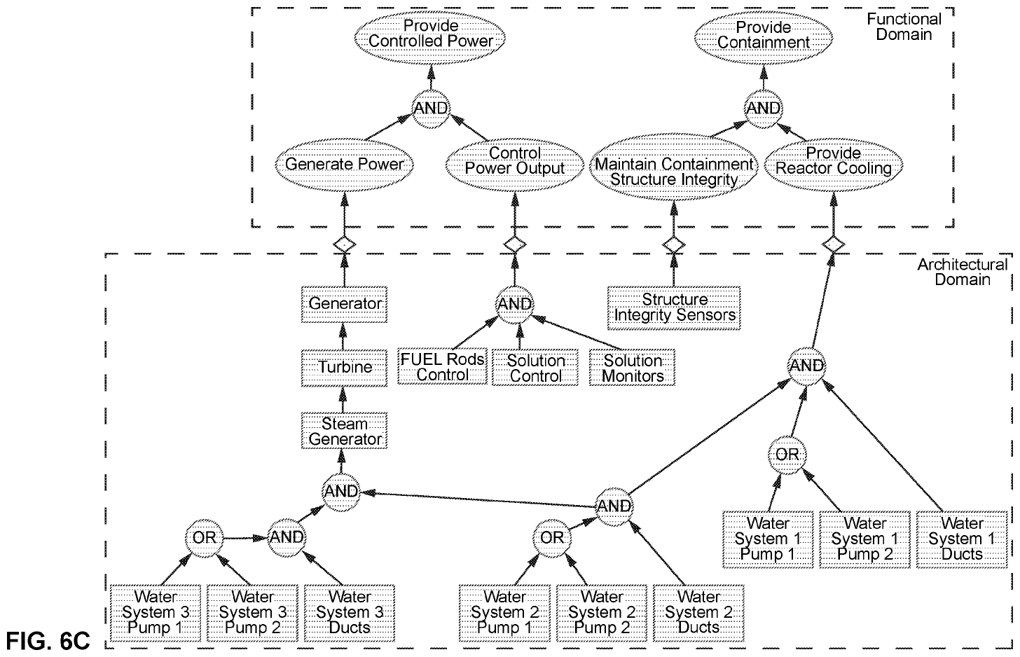

As it can be seen the SSG method is agnostic and can be applied to any system composed of sub-systems and components that interact to perform given functions, by modelling the correct system state graph and applying the same algorithm. As a non limiting embodiment FIG. 6C shows a potential simplified SSG for a nuclear power plant of the type shown in FIGS. 6A and 6B.

Example Use of the Function Ontology for Artificial Intelligence Training

As shown in the previous sections, the Function system ontology is a powerful way of describing the system and its desired states. This means that it is also an efficient way to design reward functions to train artificial intelligence algorithms to perform systems intervention by maximizing this function.

The SSG for example can be easily converted into a mathematical equation, where each function, sub-function and components states are given weighted values depending on their importance for the safe continuation of the flight (using the criticality of losing each function as per system safety assessment is a good driver for those weights—see FAA AC 25.1309), and thus can be used as a reference to train an artificial intelligence.

Example Displays

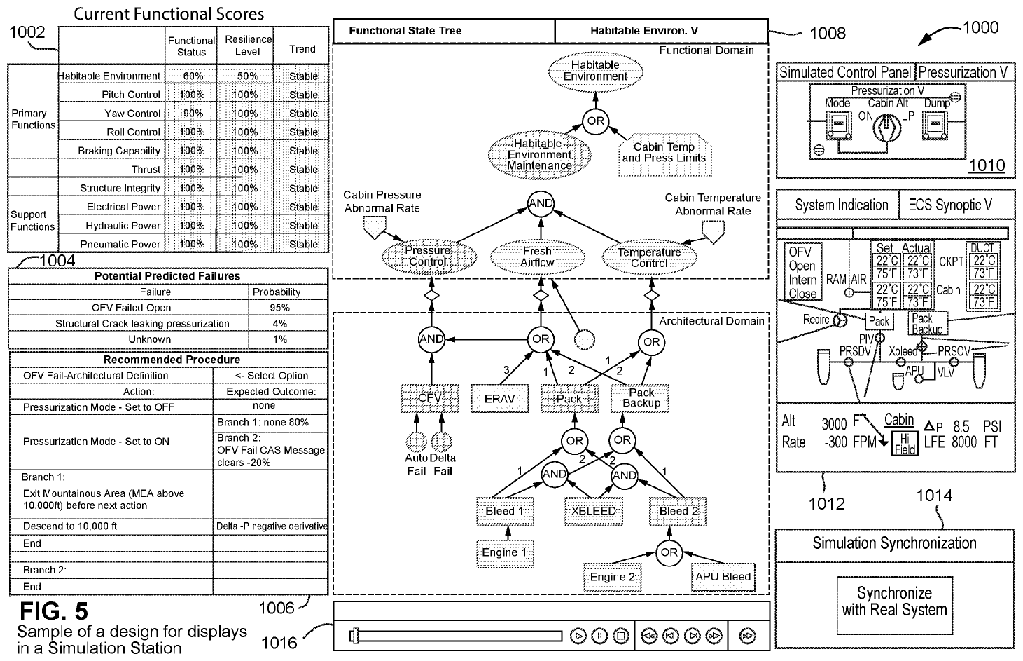

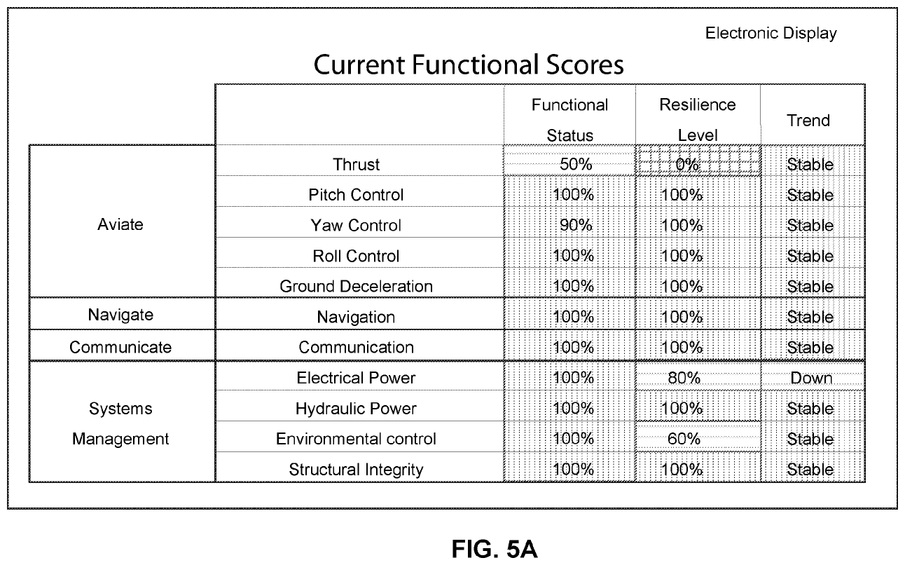

FIGS. 5 and 5A shows an example display generated by the system of FIG. 3. This section and FIGS. 5 & 5A show potential displays that can be provided for the human operator interacting with the non-limiting technology, to help guiding his decision-making process.

FIG. 5 shows an overall display that includes the following sections:
Current functional scores 1002;
Potential predicted failures 1004;
Recommended procedures 1006;
Functional state diagram 1008;
Simulated control panel 1010;
System indications 1012;
Simulation synchronization 1014;
Simulation control 1016.
   Such display sections can be displayed on a single screen or on multiple screens. For example, depending on the size of the display device, each section could be displayed in its own window or on its own screen. Conventional screen navigation techniques can be used to navigate between screens.

Example—Predicted Failures 1004

The list of predicted failures can be shown. If more than one possibility is generated by the algorithm, the options can be shown and ranked according to probability.

Example—Recommended Procedure 1006

The Recommended procedure can be shown on a display either for manual execution by a human operator (if the system is in a passive mode) or for the human operator awareness of what the system is doing. The list of forbidden or recommended actions due to the current context can be shown together with the boundary conditions that they are related to.

Example—SSG Display 1008 and Functional Status Display 1002

The SSG structure and current nodes status can be plotted on a display for the operator to immediately gain situation awareness of the systems current status. This is shown in section 1008. In some embodiments, such information could be displayed in forms other than or in addition to graphically, such as aurally.

In addition to the SSG structure, other information can also be plotted such as the overall scores for the functions if such weights for the functions have been given and implemented. See section 1002 and FIG. 5A. In addition to the pure functionality value, other values can be defined and plotted. From the SSG, a number of valuable indicators can be extracted. In one embodiment in particular, such indicators can comprise (1) functionality value, (2) function resilience value and (3) trend value:
The functionality value (for each function) expresses how well the system (in its current configuration) is capable of performing that function. A simple example is that an aircraft with two engines installed, but currently with only one operative has a 50% functionality for the “provide thrust” function. Notice that unlike this simple example shows, the functionality value is not necessarily defined only by failures in the components of the subsystems designed to implement it. In a complex system, non-obvious relationships will appear, and these are captured in the equation in order for the method to work well (thus the need for capturing design engineer and operator's tacit knowledge). An example of non-obvious relationship is the capability of using the Engines (designed to provide thrust) to provide control, through asymmetric thrust (yaw control), or using engine dynamics to control pitch (pitch up when increasing thrust for an aircraft with engines mounted below the wing/Center of Gravity). Failures may also cause non-obvious relationships, such as a fuel imbalance causing some loss of roll control. All those relationships are preferably captured when defining the functionality equation.
The resilience value (for each function) expresses how well the system (in its current configuration) is capable of supporting additional failures without losing functional capabilities. In an engine fail example for a dual engine aircraft, the resilience level for the “provide thrust” function is 0%, since a single failure of the remaining engine would bring the functionality level to 0%. The same engine failure would likely decrease the resilience level of functions like “Provide Electrical Power” due to the loss of that engine's generator, and also the resilience level of functions that need pneumatic power (such as “Provide Habitable Environment”), due to the loss of a bleed air source. Notice that this is also dependent on the system architecture since a specific aircraft could have electrically driven compressors to supply the air conditioning packs, and thus the impact on “Habitable Environment” on that aircraft could be less in that case.
The trend value (for each function) expresses if the system (in its current configuration) has the tendency of losing functionality. Back to the aircraft with an engine failure example, if that engine's generator was supposed to feed an electrical bus, that bus now can be fed only by a battery and that battery is discharging, in the current configuration no functionality has been lost yet (since the battery is feeding the bus), but the trend is that functionality will be lost in the future when the battery discharges completely (this will usually be related to Supports on the SSG). Notice that the Function and Resilience Values may in some embodiments be continuous (e.g., represented by floating point numbers) between 0 and 100%, while the trend may be implemented as a Boolean value (Stable or Not Stable), or by an integer variable (an enumeration list with assigned possibilities such as 0=Stable, 1=Down Trend, 2=Critical Down Trend, 3=Up trend, for example). However, different representations and levels of quantization are possible.

In one example embodiment, those 3 values are plotted for the operator in a functional status display. A sample design of this display is shown in FIG. 5A—Sample design of a Functional Display for an Aircraft implementation (Engine 1 Fail Scenario). This kind of display together with SSG display encapsulates the tacit knowledge of transforming an architectural model into a functional model. That transformation may not be clearly available in the frame of mind of an inexperienced pilot. Even for an experienced pilot, the display will readily give information that is not available, since conventional displays usually give only systems components status.

Note that the functional display of example non-limiting embodiments provides exactly the information about what is still working as described above in connection with the Quantas flight. It is thus an alternative resource for information gathering and immediate awareness. The ATSB report indicates in page 176 and figure All that the crew took more than 25 minutes progressing through a number of different systems and their recollection of seeking to understand what damage had occurred, and what systems functionality remained. A functional display such as the one proposed would give this information in an instant.

Example List of Possible Interventions 1006

The list of possible interventions can be shown so the operator can choose which one to use according to his own internal mental models. The scores for each one can also be shown to guide this process.

Example Simulation Station

In addition to displays, a dynamic simulation environment can be made available to the human operator so that she can simulate possible interventions and check the outcome. This is represented by block 6 in FIG. 3. This bench would have the same system model that is used by the Block 4 “Outcome Prediction” to provide this simulation capability. It also may have the following features:
System Synchronization 1014: An option that synchronizes the model used for simulation with the current system. This option can be selected to start any simulation, since the operator will want to start the simulation at the same point as the real system is. Also, after testing an unsuccessful intervention, the user will want to quickly resynchronize the model with the system, to check the next possibility. Intervention Definition partial execution: An option to quickly execute part of an intervention recommended by block 2 “Interventions definition”, so that she can quickly modify the procedure from a certain point.
Fast forward simulation: An option so that the operator can fast forward the simulation (see display section 1016) to check future conditions, for example if the fuel will be enough to reach an alternate airport.

Depending on the system and human factors analysis, the simulation station may not be suitable to have on board due to the possibility of attention tunneling or other human factors issues. But it may be very suitable for remote stations assisting the operation with larger teams (for example in a scenario where a single pilot of an aircraft is assisted by a ground station).

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of automatically determining system faults comprising:
(a) storing a model comprising a functional portion and an architectural portion, the functional portion comprising a set of functional nodes, the architectural portion comprising a set of architectural nodes, the functional nodes and the architectural nodes being linked by threshold tests;
(b) with a processor, updating nodes of the stored model based on environment, context and system sensors to reflect current operational state of the nodes;
(c) in response to detected failure state(s) of functional node(s), the processor querying the threshold tests to isolate failed architectural node(s); and
(d) based on the query, the processor searching selected architectural nodes for failure states.

2. The method of claim 1 further include interventions ontologically linked to the nodes, the interventions not extrapolating the boundaries of the nodes.

3. The method of claim 1 wherein the model comprises a directed graph.

4. The method of claim 3 wherein the directed graph comprises a System State Graph.

5. The method of claim 1 wherein at least some of the nodes have ontological meaning

6. The method of claim 1 further including a set of elementary procedures configured to be summed to define intervention for a complex set of multiple failures without being limited to predefined cases.

7. The method of claim 1 wherein the nodes comprise function nodes, component nodes, degradation nodes, supports nodes, trends nodes, functional thresholds nodes, and logics nodes.

8. The method of claim 1 further including using design reward functions to train artificial intelligence algorithms to perform systems intervention.

9. A method of modeling a failure managing framework for a complex system using a function-based intervention approach, comprising:
a. determining, with a processor, a partition of a complex system containing at least a system abstraction, and a sub-system abstraction, wherein the abstractions are operationally coupled, via their internal elements, to perform functions;
b. defining, with a processor, for each element of each abstraction, a type and a current state used to guide the execution of a specific intervention for a specific element;
c. storing the type, current state, and the mapped relationships of the elements with the explicit functions they perform in a non-transitory computer readable medium; and
d. searching, with a processor, current states of the elements to determine ontologically-defined interventions.

10. The method of claim 9, wherein the system abstraction, and the sub-system abstraction are comprised of abstract functional elements and physical concrete elements respectively.

11. The method of claim 9, wherein the type for the elements include but are not limited to, Function, Component, Degradation, Supports, Trends, Functional Threshold, and Logics.

12. The method of claim 9, wherein the current state for the elements include but are not limited to, Loss of Function, Component Reset, Component Isolation, Component Activation, Degradation Reset, Degradation Mitigation, Support Abnormal Use, and Support Depleted.

13. The method of claim 9, wherein the search includes monitoring the state of elements at a frequency dependent on system dynamics, and executes any Loss of Function and Component Isolation and Top-Down Functional Search.

14. The method of claim 13, wherein the execution of a Top-Down Functional Search is initiated at functional thresholds, and it is tasked with recovering a function that is lost.

15. An aircraft fault managing system, comprising:
a. a computer, operationally coupled to a non-transitory computer readable medium, a processor, and a display;
b. the processor being configured to model partitions of the aircraft's operational system, the model comprising a system abstraction and a sub-system abstraction, wherein the abstractions are ontologically coupled to perform functions;
c. wherein the non-transitory computer readable medium stores:
i. type, current state, and the mapped relationships of the elements with the explicit functions they perform;
ii. defined ontological intervention executions for each element; and
iii. a search algorithm, executable via the processor, configured to analyze the current states of the elements, and execute intervention.

16. The aircraft system of claim 15, wherein the elements, stored in the non-transitory computer readable medium, of the system abstraction and the sub-system abstraction comprise abstract functional elements and component elements respectively.

17. The aircraft system of claim 15, wherein the search algorithm routine monitors the state of elements of the aircraft system at a frequency dependent on system dynamics.

18. The aircraft system of claim 15, wherein the display is configured to display fault messages detected by the search algorithm, the directed graph, simulation results, and context information comprising recommended and forbidden actions.

19. The aircraft system of claim 15 wherein the model comprises a directed graph and represents an ontological database.

20. The aircraft system of claim 15 wherein the partitions comprise:
a functional partition, and
a component partition operatively coupled to the functional partition by threshold tests.

21. The aircraft system of claim 15 wherein the elements, stored in the non-transitory computer readable medium comprises a comparison method , for selecting the best through simulation and a reward function.

22. The aircraft system of claim 15 wherein the elements, stored in the non-transitory computer readable medium comprises a comparison between the simulation and the real system result providing a safety net against errors and warnings to a human backup operator.

23. An automatic fault management framework for a system, comprising:
a non-transitory memory configured to store an ontological graph model comprising a functional description comprising a set of functional nodes and ontologies, and
a processor connected to the memory, the processor performing a search of the ontological graph model to use the ontologies to provide intervention that considers the system as integrated and successfully deals with multiple concurrent system failures.
